(19) United States
(12) Patent Application Publication
(10) Pub. No.: US 2012/0235987 A1
(43) Pub. Date: Sep. 20, 2012

(54) MULTI DIMENSIONAL TOUCH DISPLAY DEVICE AND TOUCH INPUT METHOD THEREOF

(76) Inventors: Chien-Ming Lin, Kaohsiung City (TW); Ming-Ta Hsieh, New Taipei City (TW); Huang-Min Chen, Changhua County (TW); Shang-Han Yu, Changhua County (TW); Kuang-Hung Chien, Taoyuan County (TW); Chi-Chung Tsai, Kinmen County (TW); Wen-Chih Tai, Hsinchu County (TW)

(21) Appl. No.: 13/160,518

(22) Filed: Jun. 15, 2011

(30) Foreign Application Priority Data
Mar. 17, 2011 (TW) 100109162

(51) Int. Cl. G06F 3/042; G06T 19/00

(52) U.S. Cl. 345/419; 345/173; 345/175

(57) ABSTRACT

A multi-dimensional touch display device includes a multi-dimensional display device and a touch sensing device. The multi-dimensional display device is used to provide stereoscopic images with different depths. The touch sensing device connected to the multi-dimensional display device has a plurality of sensing surfaces for determining a planar coordinate and a depth of a touch input point.

### BACKGROUND OF THE INVENTION

1. Field of the Invention

The present invention is related to a multi-dimensional touch display device and a touch input method thereof, and more particularly, to the multi-dimensional touch display able to determine a depth of a touch input point and the touch input method thereof.

2. Description of the Prior Art

With the improvement of display technology, the traditional planar images can no longer meet the sensory requirement of viewers. For this reason, the development of display technology is gradually focused on stereoscopic images instead of planar images. The stereoscopic images can not only provide colorful images, but the stereoscopic visual sense. The fundamental of three-dimensional (3D) display technology is established on the parallax. Through the different optical designs, light from different pixel has respective distribution region whether in time domain or in space domain. Accordingly, the right eye and the left eye of viewer can receive individual image, and the difference of image generates the 3D visual sense after the visualization of brain.

At present, the 3D touch display device is the trend of new type electronic productions; however, current touch skills are mostly based on two-dimensional coordinates (x, y) to determine the planar coordinate of touch input point, therefore, the determination of the depth of touch input point is still infeasible. Consequently, users still can not have real-time interaction with stereoscopic images having depths.

### SUMMARY OF THE INVENTION

It is therefore one of the objectives of the present invention to provide a multi-dimensional touch display device and a touch method thereof for the better interactive experience between users and stereoscopic images.

An exemplary embodiment of the present invention provides a multi-dimensional touch display device. The multi-dimensional touch display device includes a multi-dimensional display device and a touch sensing device. The multi-dimensional display device provides stereoscopic images which have different depths. The touch sensing device which has a plurality of sensing surfaces for determining a planar coordinate and a depth of a touch input point is connected to the multi-dimensional display device.

Another exemplary embodiment of the present invention provides a method of performing touch input on stereoscopic images having different depths, and the method includes the following steps. A multi-dimensional display device is used for providing stereoscopic images with different depths. A touch input is performed at a touch input point. A touch sensing device having a plurality of sensing surfaces is used for determining a planar coordinate and a depth of the touch input point. The planar coordinate of the touch input point is compared with the stereoscopic images, and a corresponding depth of the stereoscopic image corresponding to the touch input point is obtained. A touch input function is realized when the depth of the touch input point is the same as the corresponding depth of the corresponding stereoscopic image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a function block diagram of a multi-dimensional touch display device according to an exemplary embodiment of the present invention.

FIG. 2 illustrates a schematic diagram of a multi-dimensional touch display device according to an exemplary embodiment of the present invention.

FIG. 3A illustrates an operation system diagram of a multi-dimensional touch display device according to an exemplary embodiment of the present invention.

FIG. 3B illustrates an operation process of a multi-dimensional touch display device according to an exemplary embodiment of the present invention.

FIG. 4A through FIG. 4D are schematic diagrams illustrating operation of a multi-dimensional touch display device according to an exemplary embodiment of the present invention.

### DETAILED DESCRIPTION

To provide a better understanding of the present invention, preferred embodiments will be made in detail. The preferred embodiments of the present invention are illustrated in the accompanying drawings with numbered elements.

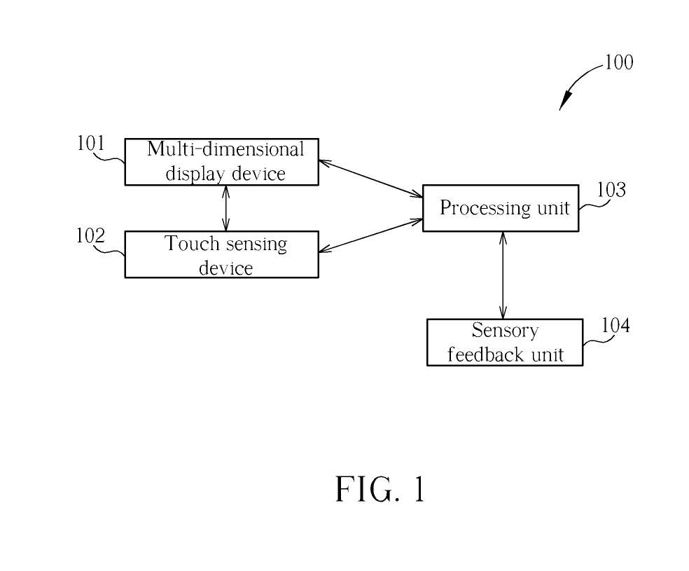

Please refer to FIG. 1. FIG. 1 illustrates a function block diagram of a multi-dimensional touch display device according to an exemplary embodiment of the present invention. As shown in FIG. 1, in this exemplary embodiment, a multi-dimensional touch display device 100 at least includes a multi-dimensional display device 101 and a touch sensing device 102. The multi-dimensional display device 101 provides stereoscopic images having different depths. The multi-dimensional display device 101 could be any type of multi-dimensional display devices. For instance, the multi-dimensional display device 101 could be auto-stereoscopic display device such as parallax barrier three-dimensional display device, lenticular three-dimensional display device, etc., or head-mounted three-dimensional display device, but not limited thereto. The touch sensing device 102 is connected to the multi-dimensional display device 101 and has a plurality of sensing surfaces. When the user performs a touch input at a touch input point, the touch sensing device 102 can determine a planar coordinate and a depth of the touch input point. The touch sensing device 102 could be any type of touch sensing devices such as resistive touch sensing device, capacitive touch sensing device, optical touch sensing device, ultrasonic touch sensing device, electromagnetic touch sensing device, or acoustic touch sensing device, but not limited thereto. The multi-dimensional touch display device 100 of this exemplary embodiment further includes a processing unit 103 and a sensory feedback unit 104. The processing unit 103 is connected to the multi-dimensional display device 101 and to the touch sensing device 102, respectively. The processing unit 103 may receive the planar coordinate of the touch input point determined by the touch sensing device 102 and compare the stereoscopic images provided by the multi-dimensional display device 101 for obtaining a corresponding depth of the stereoscopic image corresponding to the planar coordinate of the touch input point. Furthermore, the processing unit 103 can also receive the depth of the touch input point determined by the touch sensing device 102 and compare the depth of the touch input point with the corresponding depth of the corresponding stereoscopic image. When the depth of the touch input point reaches the corresponding depth of the corresponding stereoscopic image, i.e. the depth of the touch input point is the same as the corresponding depth of the corresponding stereoscopic image, the processing unit 103 sends a touch input signal to realize touch input function. Additionally, the sensory feedback unit 104 is connected to the processing unit 103. When the touch input function is realized, the sensory feedback unit 104 may provide a sensory feedback to the user. The sensory feedback may include, for example, a tactile feedback, an acoustic feedback, or a visual feedback to make the user experience the realized touch input function more directly.

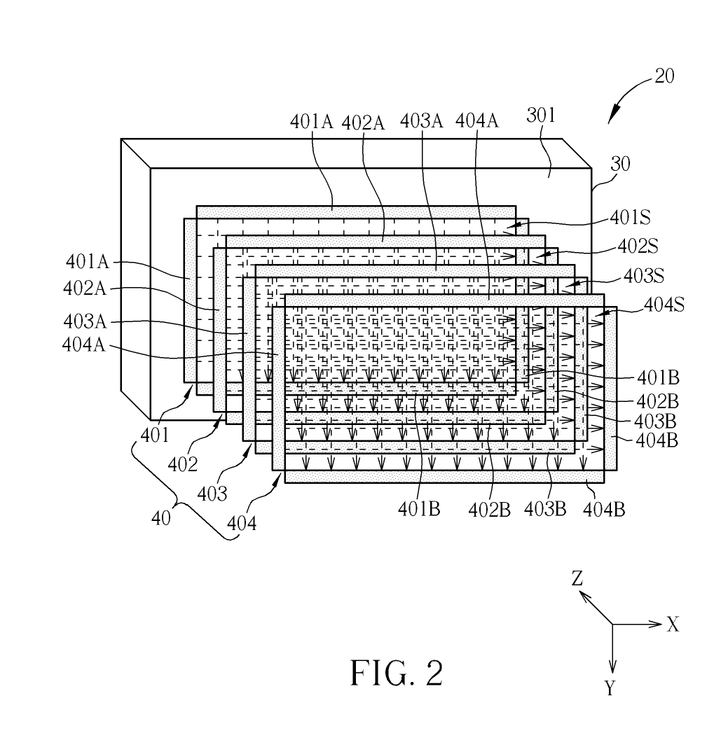

Please refer to FIG. 2. FIG. 2 illustrates a schematic diagram of a multi-dimensional touch display device according to an exemplary embodiment of the present invention. As shown in FIG. 2, a multi-dimensional touch display device 20 includes a multi-dimensional display device 30 and a touch sensing device 40, and the multi-dimensional touch display device 20 may further include a processing unit (not shown in FIG. 2) and a sensory feedback unit (not shown in FIG. 2). In this exemplary embodiment, the touch sensing device 40 includes a plurality of touch sensing units, each of the touch sensing units respectively comprises a sensing surface, and the touch sensing units are stacked on one another and disposed, as a multi-layered structure, above a display surface 301 of the multi-dimensional display device 30. For instance, the touch sensing units include a first touch sensing unit 401, a second touch sensing unit 402, a third touch sensing unit 403 and a fourth touch sensing unit 404, and these touch sensing units are stacked in order and disposed above the display surface 301 of the multi-dimensional display device 30. Furthermore, the first touch sensing unit 401 has a first sensing surface 401S, the second touch sensing unit 402 has a second sensing surface 402S, the third touch sensing unit 403 has a third sensing surface 403S, and the fourth touch sensing unit 404 has a fourth sensing surface 404S. In this exemplary embodiment, each of the touch sensing units includes an optical touch sensing unit, but not limited thereto, and each of the optical touch sensing units includes at least one optical transmitter component and at least one optical receiver component. For instance, the first touch sensing unit 401 includes at least one optical transmitter component 401A and at least one optical receiver component 401B, the second touch sensing unit 402 includes at least one optical transmitter component 402A and at least one optical receiver component 402B, the third touch sensing unit 403 includes at least one optical transmitter component 403A and at least one optical receiver component 403B, and the fourth touch sensing unit 404 includes at least one optical transmitter component 404A and at least one optical receiver component 404B. The optical transmitter/receiver components illustrated above may be infrared transmitter/receiver components for example, but not limited thereto. The optical transmitter/receiver components could be any kinds of optical transmitter/receiver components. Particularly, in this exemplary embodiment, each of the touch sensing units includes a set of optical transmitter/receiver components disposed on the two sides opposite to each other and along the horizontal direction of each touch sensing unit for determining the y-axis coordinate of touch input point, and a set of optical transmitter/receiver components disposed on the two sides opposite to each other and along the vertical direction of each touch sensing unit for determining the x-axis coordinate of touch input point. In this exemplary embodiment, the at least one optical transmitter component could be disposed on one side of each touch sensing unit, while the at least one optical receiver component could be disposed on the other side of each touch sensing unit, but not limited thereto. For instance, the at least one optical transmitter/receiver components could also be disposed alternately on the same side of each touch sensing unit. Moreover, the first touch sensing unit 401, the second touch sensing unit 402, the third touch sensing unit 403 and the fourth touch sensing unit 404 are stacked on one another and disposed above the display surface 301 of the multi-dimensional display device 30, in other words, the first sensing surface 401S, the second sensing surface 402S, the third sensing surface 403S and the fourth sensing surface 404S represent the surfaces having different depths with respect to the display surface 301 of the multi-dimensional display device 30 for determining the z-axis coordinate of touch input point. Particularly, the first sensing surface 401S, the second sensing surface 402S, the third sensing surface 4035 and the fourth sensing surface 404S can determine the distance between the user's finger and the display surface of the multi-dimensional display device 30, and further, to facilitate the realization of the touch input function at different depths. Consequently, the touch sensing device 40 of this exemplary embodiment can determine both the planar coordinate and the depth of the touch input point. It is appreciated that, the number of touch sensing units in the touch sensing device 40 is not limited to four, but can be modified according to the requirement of the multi-dimensional touch display device 20.

Each optical receiver component of each touch sensing unit provides received signal to the processing unit continuously. When a touch input occurs, a part of light from the optical transmitter components would be shaded, and the number of optical receiver components receiving light decreases. Accordingly, the received signal intensity of the partially shaded touch sensing units weakens as well. Subsequently, the processing unit compares the current received signal (with touch input) with the original received signal (without touch input) for calculating the planar coordinate and the depth of the touch input point.

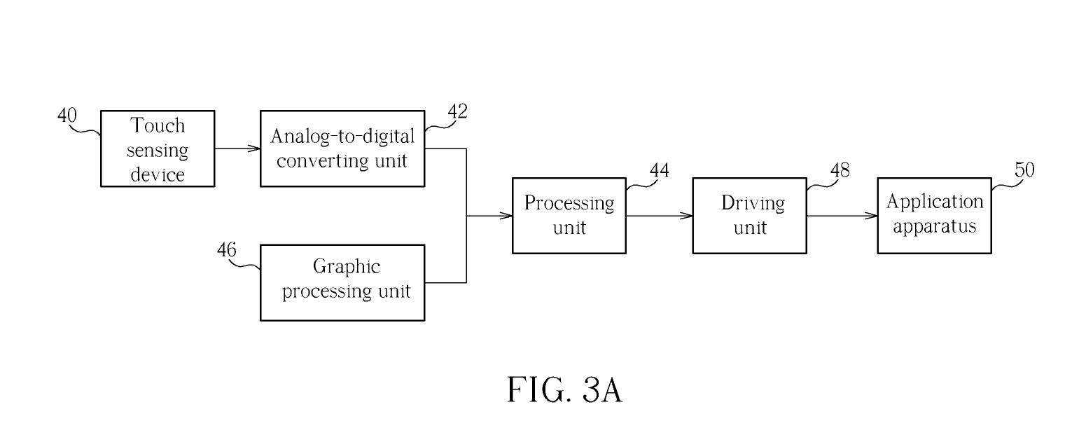

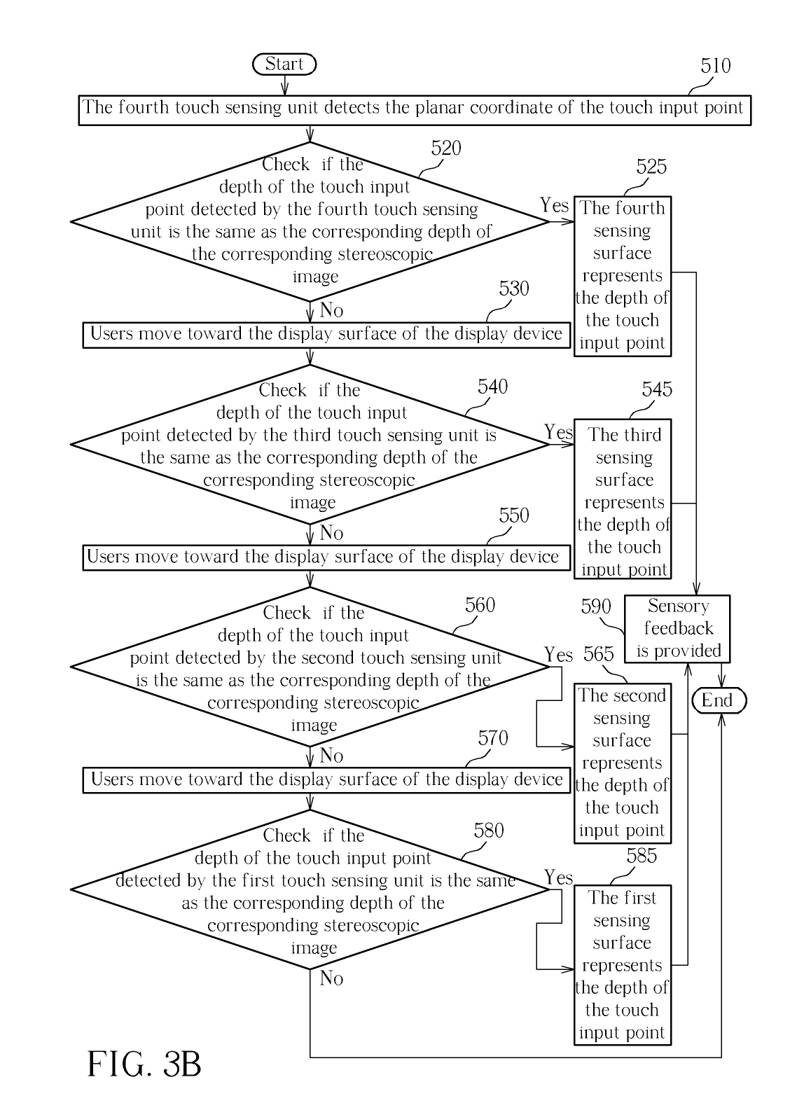

Please refer to FIG. 3A. FIG. 3A illustrates an operation system diagram of a multi-dimensional touch display device according to an exemplary embodiment of the present invention. As shown in FIG. 3A, when a touch input is performed, the touch sensing device 40 could detect the planar coordinate (x, y) of the touch input point, and an analog-to-digital converting unit 42 transforms the analog signal of the touch input point position into the digital signal and provides the digital signal of the touch point position to the processing unit 44. On the other hand, a graphic processing unit 46 also provides the depth signal of stereoscopic images corresponding to the planar coordinate of the touch input point to the processing unit 44. Then, the processing unit 44 compares the signal provided by the analog-to-digital converting unit 42 with the signal provided by the graphic processing unit 46 to confirm if the depth of the touch input point and the corresponding depth of the corresponding stereoscopic image are the same. When the depth of the touch input point is the same as the corresponding depth of the corresponding stereoscopic image, the processing unit 44 may inform a driving unit 48, and further, the driving unit 48 could drive an application apparatus 50 to realize touch input function.

For detailing the operation process of multi-dimensional touch display device according to the present invention, please refer to FIG. 3B, and refer to FIG. 2 and FIG. 3A together. FIG. 3B illustrates an operation process of a multi-dimensional touch display device according to an exemplary embodiment of the present invention. At first, when a touch input occurs, as shown in step 510, the fourth touch sensing unit 404 disposed at the outside layer of touch sensing device 40 could detect the planar coordinate (x, y) of the touch input point. Then, as shown in step 520, the processing unit 103 compares the corresponding depth of the corresponding stereoscopic image having the same planar coordinate as the touch input point with the depth of the touch input point (herein the fourth sensing surface 404S). In other words, the processing unit 103 may check if the corresponding depth of the corresponding stereoscopic image and the depth of the touch input point are the same, if yes, step 525 would be performed, otherwise, step 530 would be performed. At step 525, the depth of the touch input point is validated to be the same as the corresponding depth of the corresponding stereoscopic image, that is, the fourth sensing surface 404S could represent the corresponding depth of the corresponding stereoscopic image, and the step 590 is further performed, i.e. a sensory feedback may be provided to the users. On the other hand, at step 530, the depth of the touch input point is validated to be different from the corresponding depth of the corresponding stereoscopic image; after that, with or without the attracting signal, the users may move toward the display surface 301 of the multi-dimensional display device 30 for trying to realize the touch input function.

Then, as shown in step 540, when the touch input point is detected by the third touch sensing unit 403 of the touch sensing device 40, the processing unit 103 would compare the corresponding depth of the corresponding stereoscopic image having the same planar coordinate as the touch input point with the depth of the touch input point. In other words, the processing unit 103 may check if the corresponding depth of the corresponding stereoscopic image and the depth of the touch input point (herein the third sensing surface 4035) are the same, if yes, step 545 would be performed, otherwise, step 550 would be performed. At step 545, the depth of the touch input point is validated to be the same as the corresponding depth of the corresponding stereoscopic image, that is, the third sensing surface 403S could represent the corresponding depth of the corresponding stereoscopic image, and the step 590 is further performed, i.e. a sensory feedback may be provided to the users. On the other hand, at step 550, the depth of the touch input point is validated to be different from the corresponding depth of the corresponding stereoscopic image; after that, with or without the attracting signal, the users may move toward the display surface 301 of the multi-dimensional display device 30 for trying to realize the touch input function.

Analogically, as shown in step 560, when the touch input point is detected by the second touch sensing unit 402 of the touch sensing device 40, the processing unit 103 would compare the corresponding depth of the corresponding stereoscopic image having the same planar coordinate as the touch input point with the depth of the touch input point. In other words, the processing unit 103 may check if the corresponding depth of the corresponding stereoscopic image and the depth of the touch input point (herein the second sensing surface 402S) are the same, if yes, step 565 would be performed, otherwise, step 570 would be performed. At step 565, the depth of the touch input point is validated to be the same as the corresponding depth of the corresponding stereoscopic image, that is, the second sensing surface 402S could represent the corresponding depth of the corresponding stereoscopic image, and the step 590 is further performed, i.e. a sensory feedback may be provided to the users. On the other hand, at step 570, the depth of the touch input point is validated to be different from the corresponding depth of the corresponding stereoscopic image; after that, with or without the attracting signal, the users may move toward the display surface 301 of the multi-dimensional display device 30 for trying to realize touch input function.

Subsequently, as shown in step 580, when the touch input point is detected by the first touch sensing unit 401 of the touch sensing device 40, the processing unit 103 would compare the corresponding depth of the corresponding stereoscopic image having the same planar coordinate as the touch input point with the depth of the touch input point. In other words, the processing unit 103 may check if the corresponding depth of the corresponding stereoscopic image and the depth of the touch input point (herein the first sensing surface 401S) are the same, if yes, step 585 would be performed, otherwise, there may be no corresponding stereoscopic image having the same planar coordinate as the touch input point, and the process comes to an end. At step 585, the depth of the touch input point is validated to be the same as the corresponding depth of the corresponding stereoscopic image, that is, the first sensing surface 401S could represent the corresponding depth of the corresponding stereoscopic image, and the step 590 is further performed, i.e. a sensory feedback would be provided to the users.

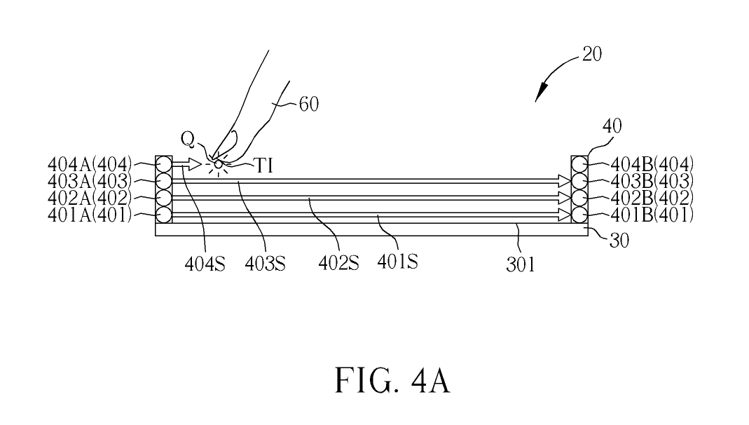

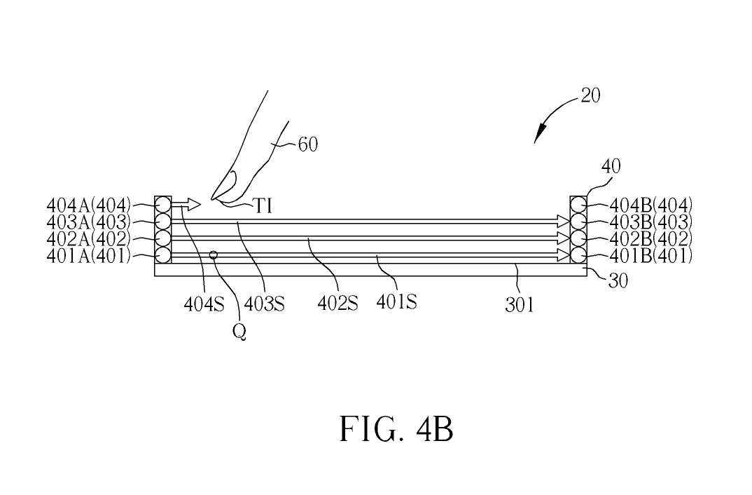

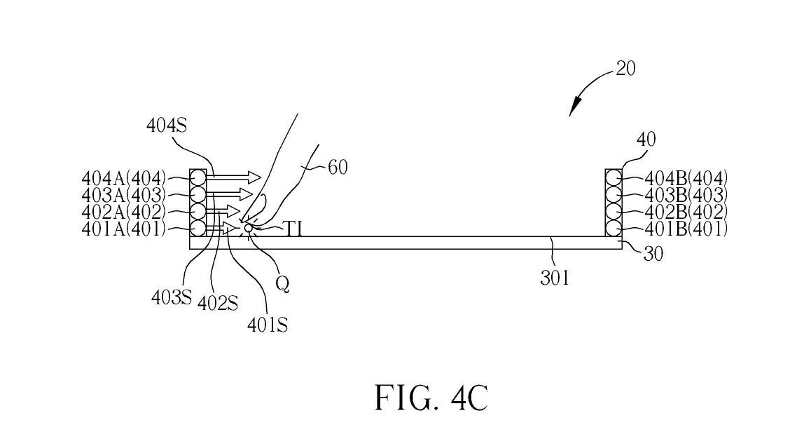

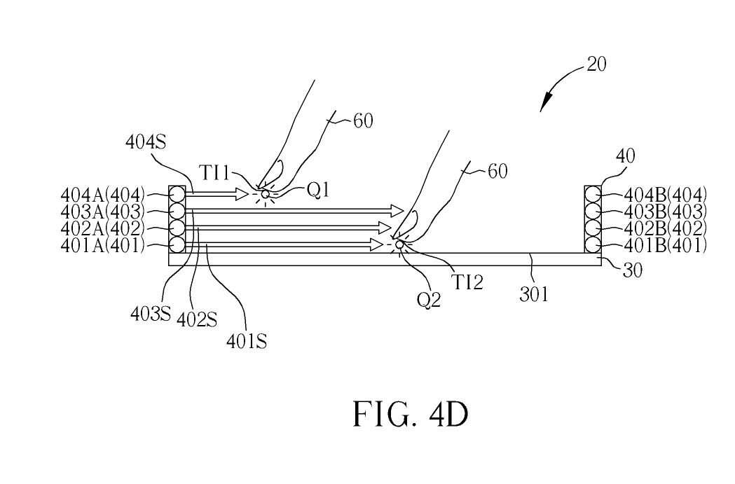

Please refer to FIG. 4A through FIG. 4D, FIG. 4A through FIG. 4D are schematic diagrams illustrating operation of a multi-dimensional touch display device according to an exemplary embodiment of the present invention. The multi-dimensional touch display device 20 includes the multi-dimensional display device 30 and the touch sensing device 40. The multi-dimensional display device 30 provides a stereoscopic sphere image Q having a depth, for instance. The touch sensing device 40 is disposed between the user and the multi-dimensional display device 30 for determining a planar coordinate and a depth of a touch input point TI of the user's finger 60. As shown in FIG. 4A, when the finger 60 touches the multi-dimensional touch display device 20, the touch input point TI is detected at the fourth sensing surface 404S, and the processing unit may select the corresponding stereoscopic images having the same planar coordinate as the touch input point TI, i.e. the stereoscopic sphere image Q provided by the multi-dimensional display device 30 and located at the fourth sensing surface 404S. Subsequently, the depth of the touch input point TI and the corresponding depth of the corresponding stereoscopic sphere image Q are compared. Because the depth of the touch input point TI is the same as the corresponding depth of the corresponding stereoscopic sphere image Q, the touch input function could be realized. Additionally, the multi-dimensional touch display device 20 may further provide a visual feedback such as a glittering stereoscopic sphere image Q.

As shown in FIG. 4B, when the finger 60 touches the multi-dimensional touch display device 20, the touch input point TI is detected at the fourth sensing surface 404S, however, the stereoscopic sphere image Q provided by the multi-dimensional display device 30 is located at the first sensing surface 401S. Since the depth of the touch input point TI is different from the corresponding depth of the corresponding stereoscopic sphere image Q, the multi-dimensional touch display device 20 would not provide any sensory feedback. Meanwhile, the user obtaining no sensory feedback will keep moving the finger 60 toward the stereoscopic sphere image Q spontaneously until sensory feedback occurs, or the multi-dimensional touch display device 20 attracts the user to move the finger 60 toward the stereoscopic sphere image Q by enlarging the stereoscopic sphere image Q as an attracting signal. It is appreciated that the method for directing the finger 60 toward the stereoscopic sphere image Q is not limited to the aforementioned method. As shown in FIG. 4C, on the way toward the stereoscopic sphere image Q, the finger 60 would pass through the second sensing surface 402S and the third sensing surface 403S. Because the depth of the touch input point TI is still different from the corresponding depth of the corresponding stereoscopic sphere image Q, no sensory feedback occurs. When the touch input point TI reaches the stereoscopic sphere image Q located at the first sensing surface 401S, the depth of the touch input point TI is the same as the corresponding depth of the corresponding stereoscopic sphere image Q, and the touch input function could be realized. Consequently, the multi-dimensional touch display device 20 would provide a visual feedback such as a glittering stereoscopic sphere image Q.

Additionally, the present invention is also feasible for multi-touch. As shown in FIG. 4D, a first touch input point TI1 and a second touch input point TI2 perform the touch input simultaneously, the finger 60 reaches a first stereoscopic sphere image Q1 at the first touch input point TI1, while another finger 60 reaches a second stereoscopic sphere image Q2 at the second touch input point TI2. When the depth of the first touch input point TI1 is the same as the corresponding depth of the corresponding first stereoscopic sphere image Q1 located at the fourth sensing surface 404S, and the depth of the second touch input point TI2 is the same as the corresponding depth of the corresponding second stereoscopic sphere image Q2 located at the first sensing surface 401S as well, the touch input function of both of the first touch input point TI1 and the second touch input point TI2 could be realized. Consequently, the multi-dimensional touch display device 20 could provide visual feedback, that is, both of the first stereoscopic sphere image Q1 and the second stereoscopic sphere image Q2 are glittering. In the present invention, the sensory feedback is not limited to visual feedback; the sensory feedback could also include a tactile feedback, an acoustic feedback, or any type of sensory feedback.

In the aforementioned embodiments, the multi-dimensional touch display device may be a three-dimensional touch display device which can provide stereoscopic display and touch input function, but not limited thereto. In another exemplary embodiment, the multi-dimensional display device may be a two-dimensional touch display device which can provide planar images and touch input function. In other words, the multi-dimensional touch display device of the present invention is feasible for users to interact with the images whether in two-dimensional mode or three-dimensional mode.

In conclusion, the present invention provides the multi-dimensional touch display device and the touch method thereof. The multi-dimensional touch display device includes the multi-dimensional display device and the touch sensing device. The touch sensing device facilitates the determination of the planar coordinate and the depth of touch input point, and the processing unit compares the depth of the touch input point and the corresponding depth of the corresponding stereoscopic image. Furthermore, when the depth of the touch input point is validated to be the same as the corresponding depth of the corresponding stereoscopic image, the sensory feedback may be provided to the user for the better interactive experience.

Those skilled in the art will readily observe that numerous modifications and alterations of the device and method may be made while retaining the teachings of the invention.

What is claimed is:

1. A multi-dimensional touch display device, comprising:
a multi-dimensional display device for providing stereoscopic images, and the stereoscopic images having different depths; and
a touch sensing device connected to the multi-dimensional display device, wherein the touch sensing device has a plurality of sensing surfaces for determining a planar coordinate and a depth of a touch input point.

2. The multi-dimensional touch display device of claim 1, wherein the touch sensing device comprises a plurality of touch sensing units, and the touch sensing units at least comprise:
a first touch sensing unit having a first sensing surface; and
a second touch sensing unit having a second sensing surface.

3. The multi-dimensional touch display device of claim 2, wherein each of the touch sensing units comprises an optical touch sensing unit, and each of the optical touch sensing units comprises at least one optical transmitter component and at least one optical receiver component.

4. The multi-dimensional touch display device of claim 2, wherein the touch sensing units are stacked on one another and disposed above a display surface of the multi-dimensional display device.

5. The multi-dimensional touch display device of claim 2, wherein the stereoscopic image corresponding to the touch input point has a corresponding depth, the first touch sensing unit is used for determining the planar coordinate and the depth of the touch input point located on the first sensing surface, and the second touch sensing unit is used for determining the depth of the touch input point located on the second sensing surface.

6. The multi-dimensional touch display device of claim 5, further comprising a sensory feedback unit, wherein the sensory feedback unit provides sensory feedback when the depth of the touch input point reaches the corresponding depth of the stereoscopic image.

7. The multi-dimensional touch display device of claim 6, wherein the sensory feedback comprises a tactile feedback, an acoustic feedback, or a visual feedback.

8. A method of performing touch input on stereoscopic images having different depths, comprising:
using a multi-dimensional (multi-dimensional) display device for providing stereoscopic images with different depths;
performing a touch input at a touch input point;
using a touch sensing device having a plurality of sensing surfaces for determining a planar coordinate of the touch input point;
comparing the planar coordinate of the touch input point with the stereoscopic images for obtaining a corresponding depth of the stereoscopic image corresponding to the touch input point; and
realizing a touch input function when the depth of the touch input point reaches the corresponding depth of the corresponding stereoscopic image.

9. The method of performing touch input on stereoscopic images having different depths of claim 8, wherein the touch sensing device comprises a plurality of touch sensing units, and the touch sensing units are stacked on one another and disposed above a display surface of the multi-dimensional display device.

10. The method of performing touch input on stereoscopic images having different depths of claim 9, wherein each of the touch sensing units comprises an optical touch sensing unit, and each of the optical touch sensing units comprises at least one optical transmitter component and at least one optical receiver component.

11. The method of performing touch input on stereoscopic images having different depths of claim 8, further comprising providing a sensory feedback when the depth of the touch input point reaches the corresponding depth of the stereoscopic image.

12. The method of performing touch input on stereoscopic images having different depths of claim 11, wherein the sensory feedback comprises a tactile feedback, an acoustic feedback, or a visual feedback.
